(19) United States
(12) Patent Application Publication
(10) Pub. No.: US 2021/0339618 A1
(43) Pub. Date: Nov. 4, 2021

(54) Operating Strategy for Hybrid Vehicles

(71) Applicant: Bayerische Motoren Werke Aktiengesellschaft, Muenchen (DE)

(72) Inventors: Michael ETZEL, Muenchen (DE); Michael FRIEDRICH, Eching (DE); Sebastian LIEBERT, Unterfoehring (DE)

(21) Appl. No.: 17/283,815

(22) PCT Filed: Nov. 13, 2019
(86) PCT No.: PCT/EP2019/081086

§ 371 Date: Apr. 8, 2021

(30) Foreign Application Priority Data
Dec. 4, 2018 (DE) 10 2018 130 886.8
Mar. 26, 2019 (DE) 10 2019 107 779.6

(51) Int. Cl. B60K 6/387; B60W 10/06; B60W 10/26; B60W 20/13

(52) U.S. Cl. CPC B60K 6/387; B60W 10/06; B60W 2710/0672; B60W 20/13; B60W 2710/021; B60W 10/26

(57) ABSTRACT

A method for implementing an operating strategy for (plug-in) hybrid vehicles. According to the method, it is possible to cause in a particularly advantageous manner an alleviation of the load of a starting device and thereby achieve emission advantages. A correspondingly configured system arrangement is provided for implementing the method. A non-transitory computer-readable medium programmed to execute the method is also provided, in which control commands implement the method and/or operate the proposed system arrangement.

### BACKGROUND AND SUMMARY OF THE INVENTION

The invention relates to a method for implementing an operating strategy for (plug-in) hybrid vehicles. According to the invention it is possible to cause the loading on a starter device to be particularly advantageously relieved, and to facilitate changes in state between purely electric operation and hybrid operation and in the process to achieve advantages in terms of emissions. In addition, the present invention relates to a correspondingly configured system arrangement. Furthermore, a computer program product is proposed with control instructions which implement the method and/or operate the proposed system arrangement.

DE 10 2007 037 758 A1 shows that in hybrid topologies a friction clutch is arranged between the internal combustion engine and the electric motor. When the clutch is opened, it is possible to drive in a purely electric fashion without the internal combustion engine having to be entrained. By closing the clutch it is possible to start the internal combustion engine out of the purely electric driving mode. The starting of the internal combustion engine is to occur as far as possible in such a way that “juddering” is avoided in the drive train as well as a loss of performance.

EP 2 729 336 B1 relates to a method for operating a hybrid drive train of a vehicle. In a hybrid vehicle, an arrangement of an internal combustion engine and of an electric machine in parallel in the force flux of the drive train, along with a mixed drive in which the drive moments of the two drive assemblies are superimposed on one another, also permits a driving operation which is purely by electric motor or purely by internal combustion engine. The changing connection of the electric machine and of the internal combustion engine to a vehicle transmission is implemented by means of disconnecting elements in such a parallel hybrid, wherein the internal combustion engine can usually be connected in terms of drive to the electric machine via a clutch.

DE 10 2010 039 194 A1 relates to a method for operating a drive train of a motor vehicle having a drive assembly which is embodied as a hybrid drive and comprises an internal combustion engine and an electric machine. A transmission is connected between the drive assembly and a drive of the drive train. A motor-side starter device is assigned to the internal combustion engine. A clutch is preferably connected between the internal combustion engine and the electric machine. When the clutch is opened, the internal combustion engine is decoupled from the drive, and only the electric machine is coupled to the drive. In contrast, when the clutch is closed, the internal combustion engine is also coupled to the output.

The known operating strategy in (plug-in) hybrid vehicles as a parallel hybrid with P2 architecture differs depending on the state of charge (SOC) of the battery between the “charge depleting” operating mode (SOC is high and SOC is reduced) and the “charge sustaining” operating mode (SOC is low and is to be maintained).

In the “charge depleting” mode, the drive is provided essentially electrically, that is to say the internal combustion engine is decoupled by means of the clutch and is set to the rotational speed 0. The frequency of starting of the internal combustion engine is low. The electric driving takes place up to high driving performance ranges.

In the “charge sustaining” mode, the internal combustion engine is preferably decoupled in overrun phases and when there is low driving power by means of the clutch and set to the rotational speed 0. Electric driving takes place only with low driving power. When there is a load request by the driver, the internal combustion engine must be started and coupled. The frequency of starting is higher than in the “charge depleting” operating mode.

SOC stands generally for state of charge and describes the state of charge of an energy accumulator. This value therefore consequently describes how far a battery is charged.

Disadvantages of the abovementioned “charge sustaining” strategy are the very high frequency of starting, losses of comfort when starting, losses of response when starting, high starting reserves in the driving power of the electric system, component loading on the starter device, component loading on the internal combustion engine, disadvantages in terms of emissions when starting and large expenditure of energy on starting, in comparison with the deactivation period of the internal combustion engine. The strategy of reducing frequency of starting by increasing SOC range brings about the CO2 disadvantages as a result of the double energy conversion.

Consequently, the known strategies and methods are very disadvantageous and there is a need for an improved method for controlling a hybrid vehicle.

An object of the present invention is to propose an improved method for implementing an operating strategy, preferably of an automobile, which overcomes the abovementioned disadvantages and can be used at the same time with the lowest possible expenditure even in existing motor vehicles. In addition, an object of the present invention is to provide a correspondingly configured system arrangement and to propose a computer program product with control instructions which implement the method and/or at least partially operate the proposed system arrangement.

The object is achieved by means of a method having the features according to the independent claims. Further advantageous refinements are disclosed in the dependent claims.

Accordingly, a method for implementing an efficient operating strategy for hybrid motor vehicles is proposed, wherein a clutch for connecting an internal combustion engine to the drive is arranged between the internal combustion engine and an electric motor, having iterative determination of a state of charge of the motor vehicle, wherein when a state of charge below a provided threshold value is determined, the internal combustion engine is coupled until the determined state of charge exceeds the provided threshold value again.

The proposed operating strategy is not primarily load-dependent but rather reacts according to the state of charge of the electrical energy accumulator and is therefore differentiated, inter alia, from known operating strategies.

It is proposed that in the “charge sustaining” mode the clutch connecting to the internal combustion engine remains closed so that the internal combustion engine is entrained in a non-energized fashion by the electric machine. Starting and deactivation of the internal combustion engine do not occur since the internal combustion engine can immediately change into the energized operating mode or can set the energization when there is a load request. The transfer of loading between the electric machine and the internal combustion engine can be implemented in a very short time. This measure is appropriate, in particular, when the internal combustion engine has drag torque reducing measures.

Advantages according to the present invention in the “charge sustaining” operating mode are significant relieving of loading on the starter device owing to elimination of the internal combustion engine start, elimination of the response disadvantages owing to the direct transfer of load of the internal combustion engine, an increase in the comfort when transferring the load of the internal combustion engine, advantages in terms of emissions as a result of less cooling of the combustion chambers of the internal combustion engine and elimination of injections at the start of the internal combustion engine, immediate operation readiness of the internal combustion engine when a load transfer is requested (since the internal combustion engine periphery, such as the fluid supply with oil, water, fuel etc., remains active during electric driving), the loading of the components of the internal combustion engine drops as a result of the elimination of starting (e.g., crankshaft bearing, cylinder sleeves . . . ), a reduction up to elimination of a power reserve in the electric system for starting and the bypassing thereof in the transfer of load from the electric driving, the elimination of the expenditure of energy on starting the internal combustion engine and the possibility of applying this uniform operating strategy in HEV, MHEV and PHEV for better following up of customers and an optimized driving experience when driving electrically.

In general, HEV, MHEV and PHEV stand for Hybrid Electric Vehicle (HEV), Mild Hybrid Electric Vehicle (MHEV) and Plugin Hybrid Electric Vehicle (PHEV).

The proposed method implements an efficient operating strategy since according to the invention the internal combustion engine is not decoupled in a certain operating mode. This is typically the case according to the prior art if the state of charge of the energy accumulator of the motor vehicle is low and consequently in this operating mode the internal combustion engine is often coupled and decoupled again. The corresponding motor vehicle is therefore typically driven by means of an electric motor which requires electrical energy. However, if the state of charge is low, it is more frequently necessary to connect an internal combustion engine.

Conventional methods react to the acceleration request of the driver by generally continuing to operate the electric motor, but the internal combustion engine is additionally coupled. Therefore, the battery or the energy accumulator of the motor vehicle is relieved and the internal combustion engine generates additional thrust. However, this coupling and decoupling of the internal combustion engine produces considerable disadvantages which are to be overcome according to the invention.

In contrast to the known methods, there is provision according to the invention that the internal combustion engine always remains coupled in the “charge sustaining” mode, and therefore also remains coupled if the internal combustion engine does not produce any power at all. Therefore, the electric motor is always operated, and the internal combustion engine is driven when there is an additional demand for power. However, according to the invention this does not require the internal combustion engine firstly to be connected, since it is always coupled by means of a closed clutch. Consequently, the invention therefore avoids carrying out a variety of coupling processes.

According to the proposed method, a system arrangement such as is already known can be re-used. For this purpose, the known system arrangement is to be actuated in such a way that the coupling processes according to the proposed method are executed in order to implement the efficient operating strategy. Therefore, according to the invention the advantage obtained at the invention can be implemented with a simple technical means and, in particular, certain motor vehicles can easily be retrofitted. For this purpose, there is typically no need for any physical adaptations but rather the proposed method can be programmed into a control device and then executed.

The clutch which is used can also be a conventional clutch which then operates in a conventional way if the threshold value is exceeded. This means that the state of charge of the motor vehicle is sufficient to essentially operate only the electric motor and to connect the internal combustion engine only rarely. According to the proposed method, the clutch is to be set in such a way that if the state of charge drops below the threshold value, the clutch is actuated in such a way that the internal combustion engine is coupled and then no longer also decoupled until a predetermined state of charge is reached again. This avoids a situation in which the coupling processes are then carried out when the state of charge of the motor vehicle is low. This is therefore advantageous in particular because, particularly at a low state of charge of the motor vehicle, the internal combustion engine has to be connected more frequently and this in turn results in the disadvantages such as are present in the prior art. These disadvantages are overcome according to the invention, and when there is a low state of charge of the motor vehicle the internal combustion engine always remains coupled.

So that it is possible to determine which operating mode the motor vehicle is in it is advantageous to determine iteratively the state of charge of the motor vehicle. The state of charge of the motor vehicle is measured here and it is consequently determined to what extent the energy accumulator of the motor vehicle is charged. As a result it can be detected whether the electric motor can typically provide the requested power alone or whether the internal combustion engine has to be frequently connected when there is a low state of charge. The state of charge is determined iteratively so that at any point in time it is known how the state of charge of the motor vehicle currently is.

The provided threshold value indicates whether an operating mode is present after which typically essentially only the electric motor provides the drive or whether the internal combustion engine has to be frequently connected. It is therefore possible to determine by means of the determined state of charge and the provided threshold value which of the drive modes already described is selected. Accordingly, when the provided threshold value is undershot, the method according to the invention can be applied in such a way that the internal combustion engine is coupled and no longer has to be decoupled until the provided threshold value is exceeded again. Overall, the provided threshold value and the determined state of charge therefore permit a conclusion to be drawn about the operating mode.

Since the state of charge of the motor vehicle is determined iteratively, the state of charge typically assumes a different value at each iteration. It is generally also possible that during the travel the energy accumulator is charged again. This occurs, for example, by means of recuperation. The state of charge of the motor vehicle therefore rises again and the provided threshold value can be exceeded again. The motor vehicle then switches into a different operating mode and it is no longer necessary for the internal combustion engine always to remain coupled. At a relatively high state of charge, the internal combustion engine is generally required less and in this respect the method according to the invention can be switched off again when the provided threshold value is exceeded.

According to one aspect of the present invention, the provided threshold value is read out from an operating mode and/or a data accumulator. This has the advantage that the coupling can be controlled with the operating mode and consequently also the provided threshold value can be selected as a function of the operating mode. Therefore, according to the invention it is possible for the provided threshold value to be that threshold value which changes between the two described operating modes. So that it is possible to change between the operating modes, there is in fact also a need for a threshold value which indicates whether the electrical energy of the motor vehicle is to be maintained or else whether it is possible to continue to consume energy and therefore to drive exclusively with electrical drive. Therefore, the proposed method can read out the provided threshold value from a data accumulator of the motor vehicle.

According to a further aspect of the present invention, the provided threshold value represents a low state of charge. This has the advantage that the threshold value can be used to determine which operating mode is selected, and the method according to the invention is then activated if a low state of charge is present. An example of the low state of charge of the energy accumulator is for example 10%, 15%, 20%, 25% or 30%. This can vary depending on the design of the motor vehicle and can be configured, for example, by the manufacturer. The low state of charge is responsible for which operating mode is selected, and this is also taken into account according to the invention. The proposed method is therefore particularly advantageous in the case of a low state of charge.

According to a further aspect of the present invention, undershooting of the provided threshold value corresponds to a “charge sustaining” operating mode. This has the advantage that that operating mode at which the advantages according to the invention are most clearly apparent can be selected. The abovementioned operating mode is typically then switched on if the motor vehicle is in a low state of charge. That is to say that the electrical energy accumulator of the motor vehicle has little charge.

According to a further aspect of the present invention, in order to couple the internal combustion engine, the clutch is closed. This has the advantage that a conventional system arrangement which is actuated according to the invention can also be used. It is therefore possible to use a conventional clutch which according to the invention is controlled in such a way that the internal combustion engine always remains coupled when there is a low state of charge.

According to a further aspect of the present invention, the internal combustion engine is entrained by the electric motor. This has the advantage that the internal combustion engine does not have to be operated per se and furthermore does not have to be decoupled either. The electric motor therefore continues to operate and merely entrains the internal combustion engine, preventing the internal combustion engine from having to be decoupled and coupled again.

According to a further aspect of the present invention, a reduction in drag torque is carried out with respect to the internal combustion engine. This has the advantage that the disadvantages of drag are overcome or minimized. There can therefore be a saving in energy here and the electric motor does not have to unnecessarily apply energy to entrain the internal combustion engine in a coupled fashion.

According to a further aspect of the present invention, the hybrid motor vehicle is in the form of a plug-in hybrid motor vehicle. The present invention has the advantage that conventional plug-in hybrid motor vehicles can be re-used and, in particular, these motor vehicles can be retrofitted with low technical expenditure. It is therefore possible to use a conventional hybrid motor vehicle which is merely adapted with respect to the control elements that the internal combustion engine is always coupled when there is a low state of charge.

The object is achieved by means of a system arrangement for implementing an efficient operation strategy for hybrid motor vehicles, wherein a clutch for connecting the internal combustion engine to the drive is arranged between an internal combustion engine and an electric motor, having a sensor system configured to determine iteratively a state of charge of the motor vehicle, wherein when a state of charge below a provided threshold value is determined, the internal combustion engine is coupled until the determined state of charge exceeds the provided threshold value again.

The object is also achieved by means of a computer program product with control instructions which execute the method and operate the proposed arrangement when they are executed on a computer.

According to the invention it is particularly advantageous that the method can be used to operate the proposed devices and units and/or the system arrangement. Furthermore, the proposed devices and apparatuses are suitable for executing the method according to the invention. Therefore, in each case the device implements the structural features which are suitable for executing the method according to the invention. The structural features can, however, also be configured as method steps. The proposed method also provides steps for implementing the function of the structural features.

Further advantages, features and details of the invention can be found in the following description in which aspects of the invention are described in detail with respect to the drawings. In this context, the features which are mentioned in the claims and in the description can each be essential to the invention individually in themselves or in any desired combination. Likewise, the features which are mentioned above and those which are explained further here can be used alone or in any desired combinations. Functionally similar or identical parts or components are in some cases provided with the same reference symbols. The terms “on the left,” “on the right,” “at the top” and “at the bottom” which are used in the description of the exemplary embodiments refer to the drawings in an orientation with a normally readable designation of the figures or normally readable reference symbols. The embodiments which are shown and described are not to be understood as conclusive but rather have an exemplary character for explaining the invention. The detailed description serves to inform a person skilled in the art, and therefore known circuits, structures and methods are not shown or explained in detail in the description, in order to avoid making the present description more difficult to understand. In the figures:

### BRIEF DESCRIPTION OF THE DRAWINGS

FIG. 1 shows a schematic block diagram of a P2 hybrid topology such as is used according to the invention; and

FIG. 2 shows a schematic flow diagram of a method for implementing an efficient operating strategy according to an aspect of the present invention.

### DETAILED DESCRIPTION OF THE DRAWINGS

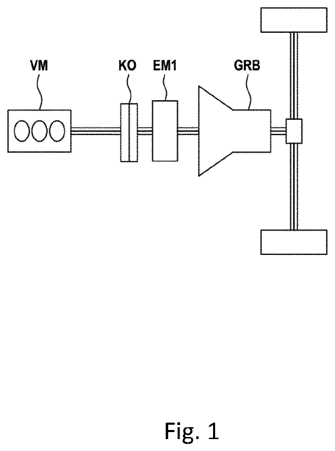

FIG. 1 shows a schematic block diagram of a P2 hybrid topology, wherein the internal combustion engine is on the left and the drive shaft on the right. The electric motor which is coupled to the internal combustion engine by means of a clutch KO is shown in the center. The wheels are shown at the top and at the bottom. The internal combustion engine and the electric motor together drive the input shaft of the transmission, and the torques of the internal combustion engine and electric motor add together to form a transmission input torque.

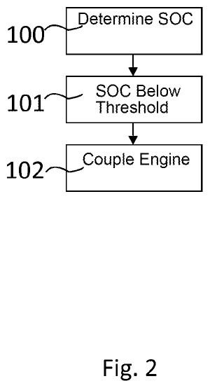

FIG. 2 shows a schematic flow diagram of a method for implementing an efficient operating strategy for hybrid motor vehicles, wherein a clutch for connecting the internal combustion engine to the drive is arranged between an internal combustion engine and an electric motor, having iterative determination 100 of a state of charge of the motor vehicle, wherein when a state of charge below a provided 101 threshold value is determined 100, the internal combustion engine is coupled 102 until the determined 100 state of charge exceeds the provided 101 threshold value again.

A person skilled in the art recognizes here that the steps can have further sub steps and, in particular, that the method steps can each be executed iteratively and/or then in a different sequence.

A data memory or a computer-readable medium with a computer program product having control instructions which implement the proposed method and/or operate the proposed system arrangement when they are executed on a computer is not shown here.

1.-10. (canceled)

11. A method for implementing an efficient operating strategy for a hybrid motor vehicle, wherein a clutch for connecting an internal combustion engine to a drive is arranged between the internal combustion engine and an electric motor, comprising:
iteratively determining a state of charge of a traction battery of the motor vehicle; and
in a case in which the state of charge is below a threshold value, coupling the internal combustion engine until the state of charge exceeds the threshold value.

12. The method according to claim 11, wherein the threshold value is read out of an operating mode and/or out of a data memory.

13. The method according to claim 11, wherein the threshold value represents a low state of charge.

14. The method according to claim 11, wherein the threshold value corresponds to a charge sustaining operating mode.

15. The method according to claim 11, wherein in order to couple the internal combustion engine the clutch is closed.

16. The method according to claim 11, wherein the internal combustion engine is entrained by the electric motor.

17. The method according to claim 11, wherein a reduction in drag torque is carried out with respect to the internal combustion engine.

18. The method according to claim 11, wherein the hybrid motor vehicle is a plug-in hybrid motor vehicle.

19. A system arrangement for implementing an efficient operating strategy for a hybrid motor vehicle, wherein a clutch for connecting an internal combustion engine to a drive is arranged between the internal combustion engine and an electric motor, comprising:
a sensor system that iteratively determines a state of charge of the motor vehicle;
wherein, in a case in which the state of charge is below a threshold value, the internal combustion engine is coupled until the state of charge exceeds the threshold value.

20. A non-transitory computer-readable medium programmed to execute on a computer a method for implementing an efficient operating strategy for a hybrid motor vehicle, wherein a clutch for connecting an internal combustion engine to a drive is arranged between the internal combustion engine and an electric motor, the method comprising:
iteratively determining a state of charge of a traction battery of the motor vehicle; and
in a case in which the state of charge is below a threshold value, coupling the internal combustion engine until the state of charge exceeds the threshold value.
